(19) United States
(12) Patent Application Publication
(10) Pub. No.: US 2019/0107944 A1
(43) Pub. Date: Apr. 11, 2019

(54) Multifinger Touch Keyboard

(71) Applicant: Microsoft Technology Licensing, LLC, Redmond, WA (US)

(72) Inventors: Andrew Stuart GLASS, Seattle, WA (US); Ricardo Arturo ESPINOZA REYES, Redmond, WA (US); Raymond QUAN, Shoreline, WA (US); Sophors KHUT, Seattle, WA (US); Christian KLEIN, Duvall, WA (US)

(73) Assignee: Microsoft Technology Licensing, LLC, Redmond, WA (US)

(21) Appl. No.: 15/727,442

(22) Filed: Oct. 6, 2017

(51) Int. Cl. G06F 3/0488; G06F 3/042; G06F 3/041

(52) U.S. Cl. CPC G06F 3/04886; G06F 3/0426; G06F 2203/04104; G06F 3/0416; G06F 3/04883; G06F 3/0412

(57) ABSTRACT

Implementations described herein provide a multifinger keyboard that is generated based on detected input. Each key of the multifinger keyboard includes multiple input zones, which are positioned and dimensioned to correlate with a present orientation of a user's fingers. The multifinger keyboard is automatically regenerated to account for drift and other changes in position of a user's hand relative to the keyboard, thereby providing reliable targeting without requiring physical homing indicators. Each input zone may be associated with different output values, such that applying different input types to a single input zone results in different outputs. Potential outputs are determined based on concurrent inputs received at the multifinger keyboard, from which a final output is generated.

### BACKGROUND

Computing devices implement touch-based devices to support a variety of different input configurations on a single device, such as touchscreen keyboards. However, unlike physical QWERTY keyboards that include raised indentations on the “F” and “J” keys, touch keyboards often lack physical homing indicators. Because device users are forced to look at the keyboard while typing in order to target correctly, conventional touch-based keyboards are often inefficient and cumbersome to operate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Implementations described herein provide a multifinger keyboard that is generated based on detected input. Each key of the multifinger keyboard includes multiple input zones, which are positioned and dimensioned to correlate with a present orientation of a user's fingers. The multifinger keyboard is automatically regenerated to account for drift and other changes in position of a user's hand relative to the keyboard, thereby providing reliable targeting without requiring physical homing indicators. Each input zone may be associated with different output values, such that applying different input types to a single input zone results in different outputs. Potential outputs are determined based on concurrent inputs received at the multifinger keyboard, from which a final output is generated.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more implementations.

FIG. 2 depicts an example implementation scenario for generating an output from a multifinger keyboard in accordance with one or more implementations.

FIG. 3 depicts an example implementation scenario for generating a multifinger keyboard based on received gesture input in accordance with one or more implementations.

FIG. 4 depicts an example implementation scenario for generating different input zones for individual keys of a multifinger keyboard in accordance with one or more implementations.

FIG. 5 depicts an example implementation scenario for generating an auxiliary key for a multifinger keyboard in accordance with one or more implementations.

FIG. 6 depicts an example implementation scenario for disambiguating potential outputs to generate a final output in accordance with one or more implementations.

FIG. 7 is a flow diagram that describes steps in a method for generating a final output based on input received at a multifinger keyboard in accordance with one or more implementations.

FIG. 8 is a flow diagram that describes steps in a method for generating a multifinger keyboard based on received gesture input in accordance with one or more implementations.

FIG. 9 is a flow diagram that describes steps in a method for a modifying a keyboard based on detected movement in accordance with one or more implementations.

FIG. 10 illustrates an example system and computing device as described with reference to FIG. 1, which are configured to implement implementations of techniques described herein.

### DETAILED DESCRIPTION

Implementations described herein enable generation of a multifinger keyboard that adapts to a current position of a user's hand in order to provide reliable input targeting. This enables accurate interpretation of touch input even when a user does not have line of sight to an input device. Generally, the described techniques can be implemented in a range of different input devices, such as touchscreens, track pads, camera-based, motion sensor-based, wearable devices, and the like.

For instance, consider a scenario where a user invokes a keyboard using a multifinger touch gesture, such as by tapping on an input device surface using three fingers. Using the techniques described herein, a location and position for each of the three fingers are determined, relative to an input surface of the input device. Based on this location and position information for each finger, individual keys of the multifinger keyboard are dimensioned and positioned to align with the three fingers. Further, an estimated range of motion is determined from the current position of each finger so that the individual keys encompass an area in which the finger can initiate inputs without radial or ulnar movement of a hand. The keys are each generated to include multiple input zones, which are also dimensioned and positioned to account for a finger's available range of motion. Each input zone can be associated with one or more output values, such that concurrent inputs to the different keys can be used to generate diverse combinations of outputs across a range of different applications. As described herein, a “finger” refers to any of the five digits of a user's hand: a thumb, an index finger, a middle finger, a ring finger, or a pinky finger.

Implementations further monitor received input to determine when a user's hand drifts or repositions relative to the device, such that subsequent inputs to the multifinger keyboard are no longer reliable to be on target. In response to such a determination, the multifinger keyboard is regenerated at a position with individual keys dimensioned to account for any repositioning. Thus, the techniques described herein provide for a multifinger keyboard that can be implemented among a variety of input devices for efficient and reliable input operations.

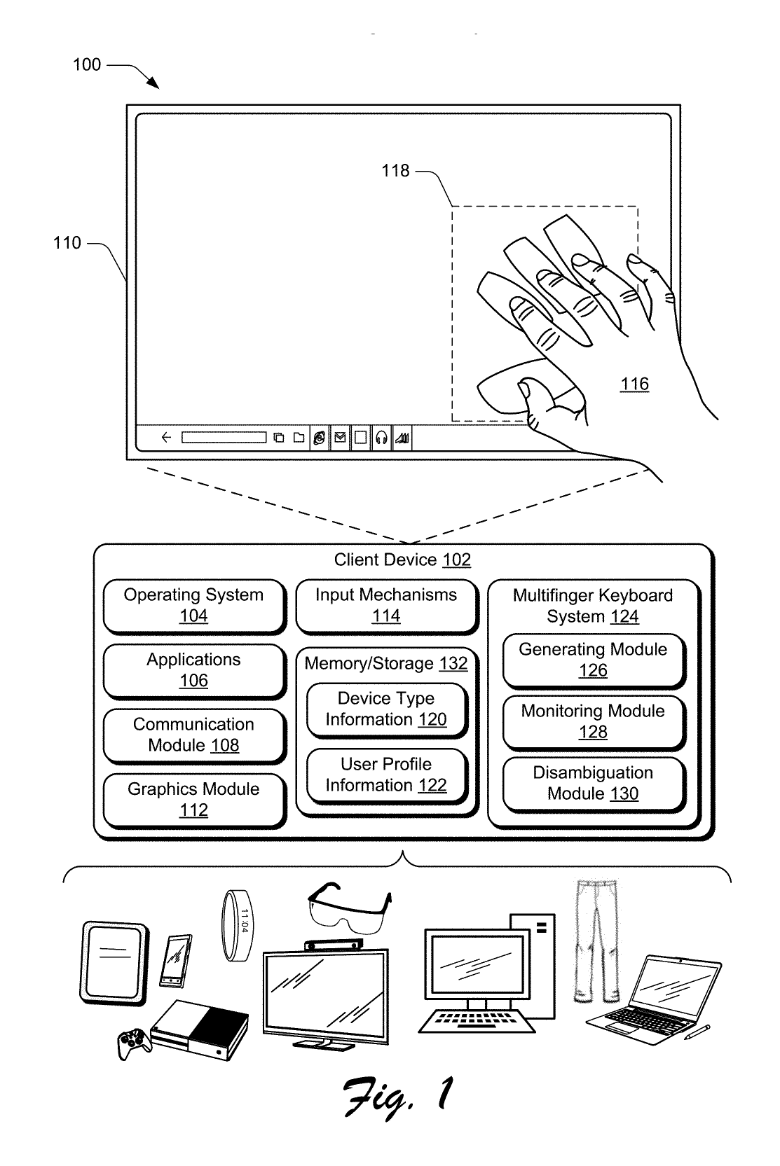

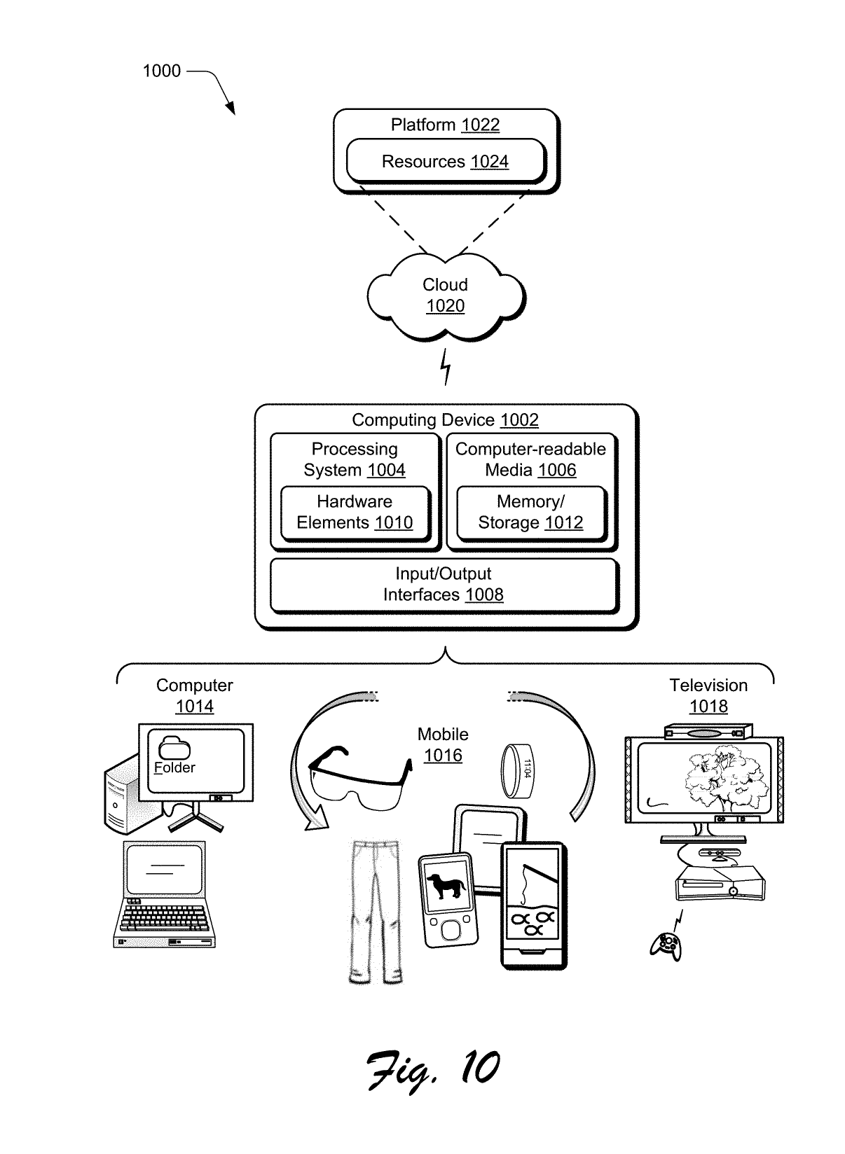

FIG. 1 is an illustration of an environment 100 in an example implementation that is operable to employ techniques for generating a multifinger keyboard and determining outputs from the multifinger keyboard, as described herein. Environment 100 includes a client device 102 which can be embodied as any suitable device such as, by way of example and not limitation, a smartphone, a tablet computer, a portable computer (e.g., a laptop), a desktop computer, a wearable device, a device integrated into clothing, and so forth. In at least some implementations, the client device 102 represents a smart appliance, such as an Internet of Things (“IoT”) device. Thus, the client device 102 may range from a system with significant processing power, to a lightweight device with minimal processing power. One of a variety of different examples of the client device 102 is shown and described below in FIG. 10.

The client device 102 includes a variety of different functionalities that enable various activities and tasks to be performed. For instance, the client device 102 includes an operating system 104, applications 106, and a communication module 108. Generally, the operating system 104 is representative of functionality for abstracting various system components of the client device 102, such as hardware, kernel-level modules and services, and so forth. The operating system 104, for instance, can abstract various components (e.g., hardware, software, and firmware) of the client device 102 to the applications 106 to enable interaction between the components and the applications 106.

The applications 106 represents functionalities for performing different tasks via the client device 102. Examples of the applications 106 include a word processing application, a spreadsheet application, a web browser, a gaming application, and so forth. The applications 106 may be installed locally on the client device 102 to be executed via a local runtime environment, and/or may represent portals to remote functionality, such as cloud-based services, web apps, and so forth. Thus, the applications 106 may take a variety of forms, such as locally-executed code, portals to remotely hosted services, and so forth.

The communication module 108 is representative of functionality for enabling the client device 102 to communicate over wired and/or wireless connections. For instance, the communication module 108 represents hardware and logic for communication via a variety of different wired and/or wireless technologies and protocols.

The client device 102 further includes a display device 110, a graphics module 112, and input mechanisms 114. The display device 110 generally represents functionality for visual output for the client device 102. Additionally, the display device 110 represents functionality for receiving various types of input, such as touch input, pen input, and so forth. The display device 110, for instance, represents an instance of the input mechanisms 114, such that the display device 110 is configured to receive touch based inputs from a user's hand 116, a stylus, and so forth.

The graphics module 112 is representative of functionality for generating graphics data for output via the display device 110. The graphics module 112, for instance, includes a rendering engine that can process and output data for display on the display device 110. For example, the graphics module 112 can implement the techniques described herein to cause display of the multifinger keyboard displayed within the bounded region 118, as described in further detail below.

The input mechanisms 114 generally represent different functionalities for receiving input to the client device 102, and include touch input devices and touchless input devices. Examples of the input mechanisms 114 include gesture-sensitive sensors and devices (e.g., such as touch-based sensors and movement-tracking sensors (e.g., camera-based)), a mouse, a keyboard, a stylus, a touch pad, accelerometers, a microphone with accompanying voice recognition software, and so forth. The input mechanisms 114 may be separate or integral with the display device 110, with integral examples including gesture-sensitive displays with integrated touch-sensitive or motion-sensitive sensors.

The client device 102 additionally includes device type information 120 for the client device as well as user profile information 122 describing one or more user profiles associated with the client device. The device type information 120 describes the client device 102, such as a serial number, a manufacturer, a model, a hardware specification, a software specification, combinations thereof, and so forth. Alternatively or additionally, the device type information 120 describes current and historical activity for the operating system 104, applications 106, communication module 108, graphics module 112, input mechanism, multifinger keyboard system 124, generating module 126, monitoring module 128, and/or the disambiguation module 130. Generally, the user profile information 122 describes a particular user and historical data describing a manner in which the particular user interacts with the client device 102, such as voice training data, gesture training data, recorded input data, and so forth. In some implementations, the device type information 120 and user profile information 122 are stored in memory/storage 132 of the client device 102, as described in further detail below with respect to FIG. 10.

The client device 102 additionally includes a multifinger keyboard system 124, which is representative of functionality for generating a multifinger keyboard, monitoring inputs received at the multifinger keyboard, and disambiguating among potential outputs to determine a final output based on the monitored inputs. For instance, the keyboard system 124 includes a generating module 126, a monitoring module 128, and a disambiguation module 130. As further described below, techniques described herein enable the generating module 126 to generate a multifinger keyboard based on detected input locations and detected input profiles for different fingers of a multifinger gesture. In some implementations, the multifinger keyboard system 124 is implemented in one of the input mechanisms 114. Alternatively or additionally, the multifinger keyboard system 124 is representative of functionality integrated into the applications 106. Alternatively or additionally, the multifinger keyboard system 124 is implemented as part of the operating system 104.

The techniques described herein additionally enable the monitoring module 128 to monitor for inputs received at the multifinger keyboard, generate potential outputs from the received inputs, and determine when it is necessary to generate a new multifinger keyboard. The techniques described herein additionally enable the disambiguation module 130 to determine a final output based on the potential outputs, which can be output for display at the display device 110 in some implementations. Thus, the keyboard system 124 is configured to generate a multifinger keyboard that automatically accounts for user drift and repositioning. This enables a compact keyboard that can be operated with a single hand and without requiring homing indicators or line of sight.

Having described an example environment in which the techniques described herein may operate, consider now a discussion of some example implementation scenarios for a multifinger keyboard in accordance with one or more implementations. The implementation scenarios may be implemented in the environment 100 described above, the system 1000 of FIG. 10, and/or any other suitable environment.

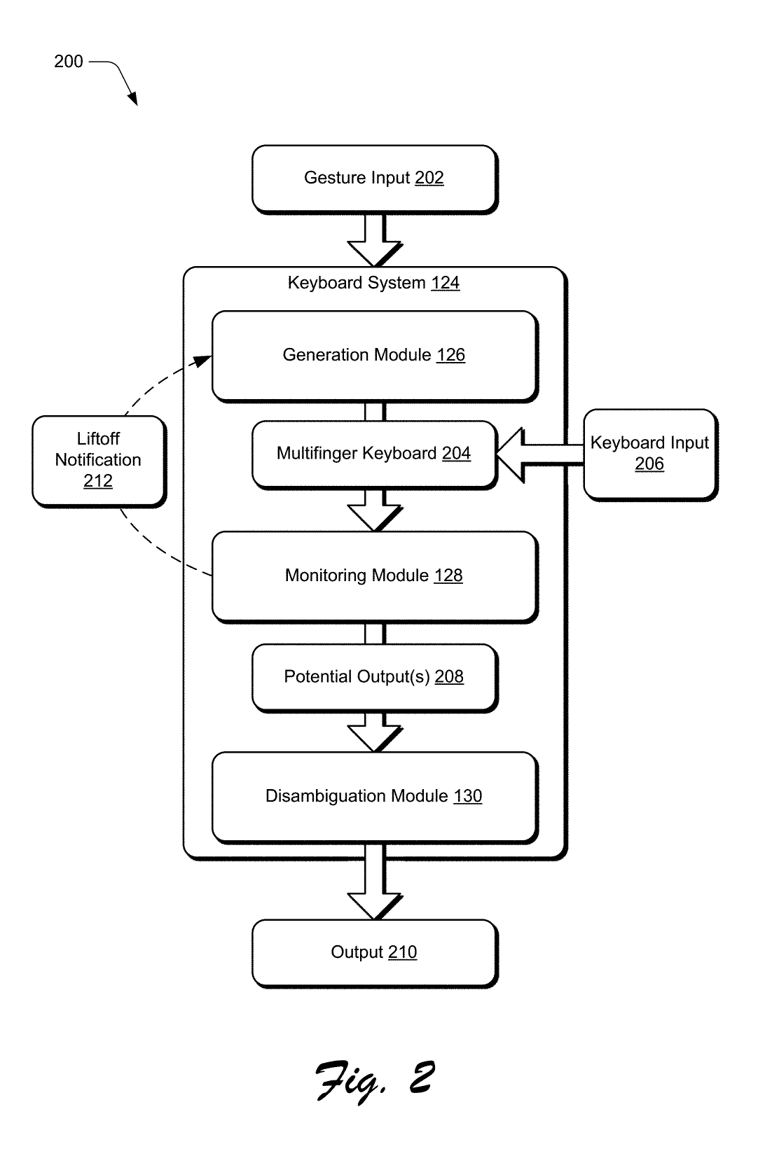

FIG. 2 depicts an example implementation scenario 200 for generating an output from a multifinger keyboard in accordance with one or more implementations. The scenario 200 includes the keyboard system 124 and its generation module 126, monitoring module 128, and disambiguation module 130, as illustrated in FIG. 1. Gesture input 202 is received by the keyboard system 124, such as from the input mechanisms 114, as illustrated in FIG. 1. In some implementations, the gesture input 202 is received as a three-finger tap gesture, where an indication of near-simultaneous taps of three different fingers is received by the keyboard system 124.

Alternatively or additionally, the gesture input 202 may be any type of input that is recognizable by the keyboard system 124 to initiate generation of a multifinger keyboard. For instance, the gesture input 202 may be a touchless gesture, a voice command, activation of a button on a computing device implementing the keyboard system 124, and so forth. In some implementations, the gesture input 202 may be user-defined to include a specific type or types of input useable to instruct generation of a multifinger keyboard.

In response to receiving the gesture input 202, the generation module 126 determines a location of three fingers to be used to operate a multifinger keyboard. For instance, in an implementation where the gesture input 202 is a three-finger tap on a touchscreen, the generation module 126 identifies a location for each finger of the three-finger tap relative to the touchscreen. Additionally, the generation module 126 determines an input profile for each finger of the three-finger tap to ascertain a finger's position during the gesture input 202. For instance, as a finger moves over a surface, properties useable to define an input profile, such as a change in contact point between the finger and the surface, a rotation of the finger, a stretch of the skin, and so forth will vary with the finger's position.

As described in further detail below, the generation module 126 additionally accounts for inadvertent drift that might occur during operation of the multifinger keyboard. For instance, in an implementation where the gesture input 202 is a three-finger double-tap, the generation module 126 may register two different positions for a single finger, one position for each of the double taps. In this implementation, the generation module 126 may determine an average of the two disparate touch locations to use as the touch location for the finger. Alternatively or additionally, the generation module 126 may define a touch location for the finger as an area that encompasses the two disparate touch locations detected during the double tap. Thus, by determining both individual locations and input profiles for three different fingers, the generation module 126 is able to determine how a user's hand is positioned relative to an input device for generating a multifinger keyboard.

The generation module 126 additionally determines an input device type to which the gesture input 202 is received. For instance, the generation module 126 is configured to differentiate between a flat touchscreen, a flat trackpad with a small form factor, a flexible fabric such as an input device integrated into fabric of a pair of pants, a touchless input device, and so on. By determining the type of input device at which the gesture input 202 was received, the generation module 126 is configured to predict a manner in which different fingers will move relative to the input device. Thus, the generation module 126 determines respective positions and input profiles for three fingers as well as an input device type based on the received gesture input 202.

Based on the touch positions, input profiles, and input device type, the generation module 126 generates a multifinger keyboard 204. As described in further detail herein, the multifinger keyboard 204 includes three different keys that are each defined as an area of the input device at which the gesture input 202 was received. The keys of the multifinger keyboard 204 are dimensioned and positioned based on the detected touch locations, input profiles, and input device type. Additionally or alternatively, the keys of the multifinger keyboard 204 are dimensioned based on historical user input data. For instance, historical user input data may include information describing a typical travel path for a user's ring finger as being associated with a certain input profile for the ring finger. In this manner, the generation module 126 can dimension a key corresponding to the user's ring finger to encompass the typical travel path, such that the multifinger keyboard 204 is customized for the user.

In addition to positioning and dimensioning the individual keys of the multifinger keyboard 204, the generation module 126 further defines at least three different input zones for each individual key, as described in further detail below. Each key of the multifinger keyboard can thus be activated by a single finger, such that different outputs can be generated based on a position of the finger relative to the keyboard, a gesture performed by the finger, and so forth.

Using the techniques described herein, the different input zones for a single key can be dimensioned based on the touch position and input profile of a finger as well as the input device type used in receiving the gesture input 202. Additionally or alternatively, the generation module 126 dimensions input zones for a key based on historical user input data, as described in further detail below.

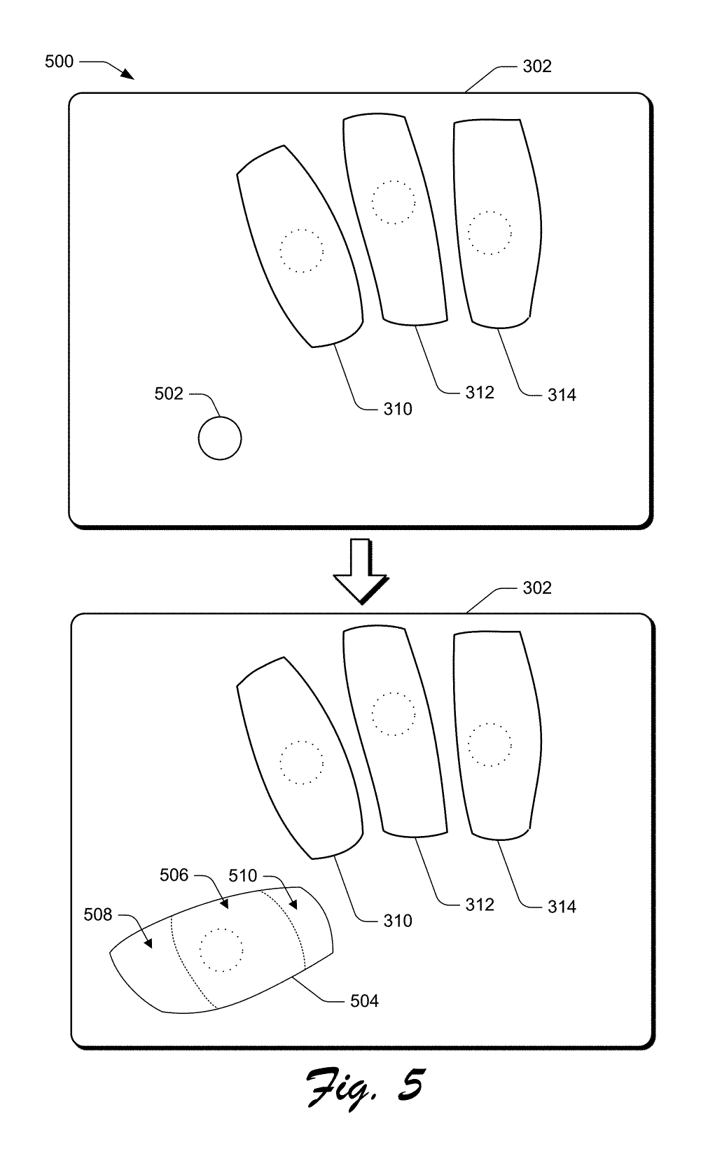

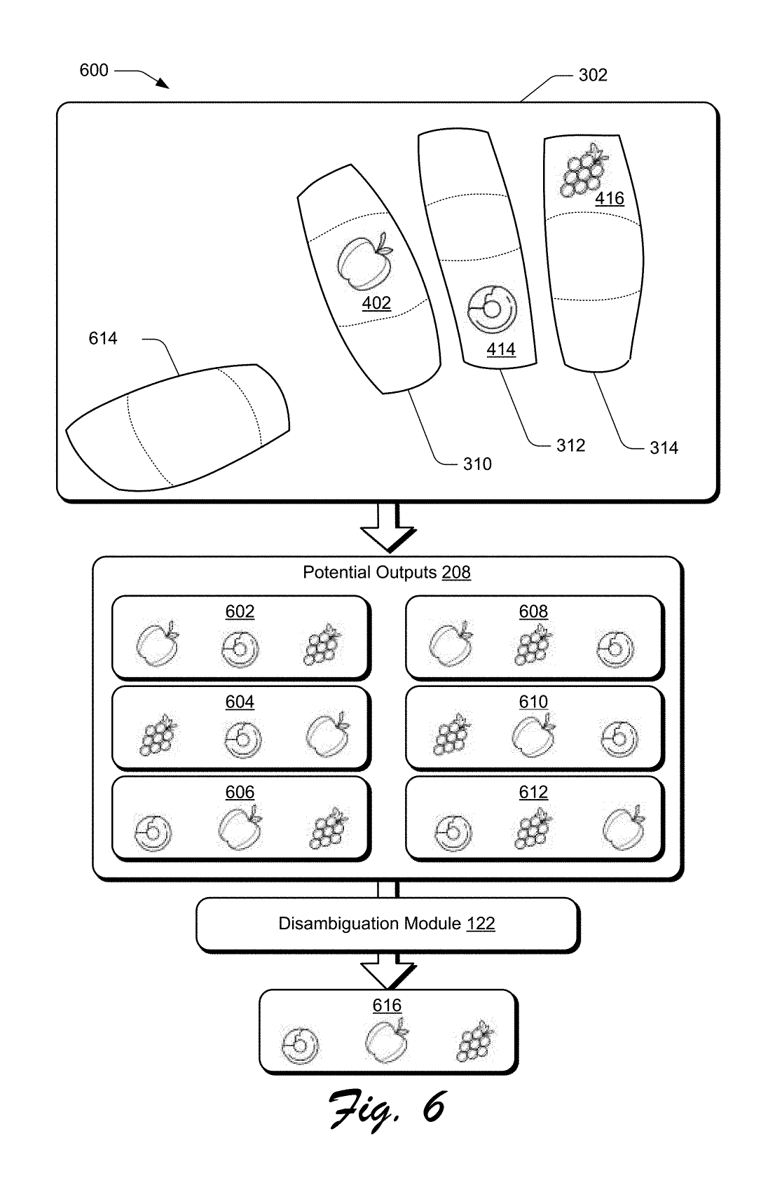

Thus, the generation module 126 is configured to generate the multifinger keyboard 204 such that the keyboard's keys are located based on a position of the user's fingers, which eliminates the need for a user to reposition in order to conform to a pre-defined keyboard structure. In some implementations, the generation module 126 generates the multifinger keyboard 204 to include an additional auxiliary key, as described in further detail below with respect to FIGS. 5 and 6. Although described herein as generating the multifinger keyboard 204 based on positions and orientations of a user's fingers, the generation module 126 is alternatively or additionally configured to generate the multifinger keyboard 204 based on a detected position and orientation of the user's palm. The generation module 126 generates

Upon generation of the multifinger keyboard 204, the monitoring module 128 monitors each key of the multifinger keyboard for inputs, represented by the keyboard input 206. The monitoring module 128 simultaneously monitors the different input zones for each key of the three finger-keyboard to determine input locations detected at each key. Based on an input configuration for the multifinger keyboard 204, the monitoring module 128 determines at least one potential output 208 from the received keyboard input 206. In addition to detecting input locations for the keyboard input 206, the monitoring module 128 is additionally configured to identify and differentiate among different types of input received as part of the keyboard input 206. For instance, the monitoring module 128 can distinguish between a tap and a swipe gesture received at a common input zone. Thus, in some implementations the at least one potential output 208 is generated based on an input type of the received keyboard input 206.

The monitoring module 128 is further configured to monitor drift that may occur while a user interacts with the multifinger keyboard 204. For instance, a hand's overall position relative to an input device may shift during ongoing use of the multifinger keyboard 204. In some implementations, drift may result in a scenario where the fingers of the hand are no longer positioned within respective input areas for keys of the multifinger keyboard 204 and may result in inadvertent key actuations. Similarly, after lifting off an input device supporting the multifinger keyboard 204, a user may resume contact with fingers positioned in a different location, a different orientation, and so forth. Accordingly, to ensure that respective input areas of the multifinger keyboard 204 remain positioned and dimensioned according to a current state of a user's hand, the monitoring module 128 informs the generation module 126 when a new instance of the multifinger keyboard 204 needs to be generated.

For instance, the monitoring module 128 may communicate a liftoff notification 212 to the generation module 126 to indicate that a user has either lifted fingers off the input device or drifted outside input zones for the multifinger keyboard 204, such that subsequent inputs to the multifinger keyboard 204 are no longer reliable. In some implementations, the liftoff notification 212 is generated based on a detected location and orientation of the user's palm. For instance, the monitoring module 128 may abstain from generating liftoff notification 212 in response to determining that a position and orientation of the user's palm has changed with respect to an input device, even if fingers of the user's hand have lifted off the input device. The liftoff notification 212 may be communicated with information describing a current touch position and input profile for each finger used in operating the multifinger keyboard 204. Upon receipt of the liftoff notification 212, the generation module 126 generates a new instance of the multifinger keyboard 204 to account for a current position of a user's hand. In this manner, the keyboard system 124 generates a new instance of the multifinger keyboard 204 to account for repositioning of a user's hand and generate reliable potential outputs 208.

The monitoring module 128 communicates the at least one potential output 208 to the disambiguation module 130 in order to generate a final output 210. As described in further detail below, because an input zone for a single key of the multifinger keyboard 204 may be associated with multiple output values, a single input may be used to generate different outputs. In such a scenario where a given input is associated with multiple potential outputs 208, the disambiguation module 130 identifies at least one of the potential outputs 208 for use as the final output 210. In some implementations, the disambiguation module 130 visually presents at least one option that will be used as the output 210 for user selection or affirmation.

For instance, in an implementation where the multifinger keyboard 204 is configured for cursor control, the potential outputs 208 may include selection of a folder icon and a selection of a file icon adjacent to the folder icon. The disambiguation module 130 may visually emphasize (e.g., highlight) the folder icon to indicate that the selection of the folder icon will be used as the final output prior to generating output 210. Likewise, in an implementation where the multifinger keyboard 204 is configured for alpha-numeric input, the disambiguation module 130 may present a list of words that can be generated based on the received keyboard input 206 to enable user selection of an intended word. In some implementations, user selection of the final output is performed using an auxiliary key of the multifinger keyboard 204, as described in further detail below.

In this manner, the disambiguation module 130 is configured to identify an intended output from the potential outputs 208 for use as the output 210. Alternatively or additionally, the disambiguation module 130 may generate the output 210 independent of user input beyond the keyboard input 206. For instance, continuing the alpha-numeric input configuration example, the disambiguation model 130 may automatically select an output based on a dictionary describing average frequencies of word usage for a designated language by selecting the most frequently used word from the potential outputs 208.

After generating the output 210, the keyboard system 124 communicates the output 210 for display, such as for display at display device 110, as illustrated in FIG. 1. As described herein, the monitoring module 128 is configured to monitor for subsequently received keyboard input 206 while the disambiguation module 130 is generating the output 210 from the potential outputs 208. In this manner, the keyboard system 124 is configured to regenerate the multifinger keyboard and generate outputs 210 in real time as the keyboard input 206 is received.

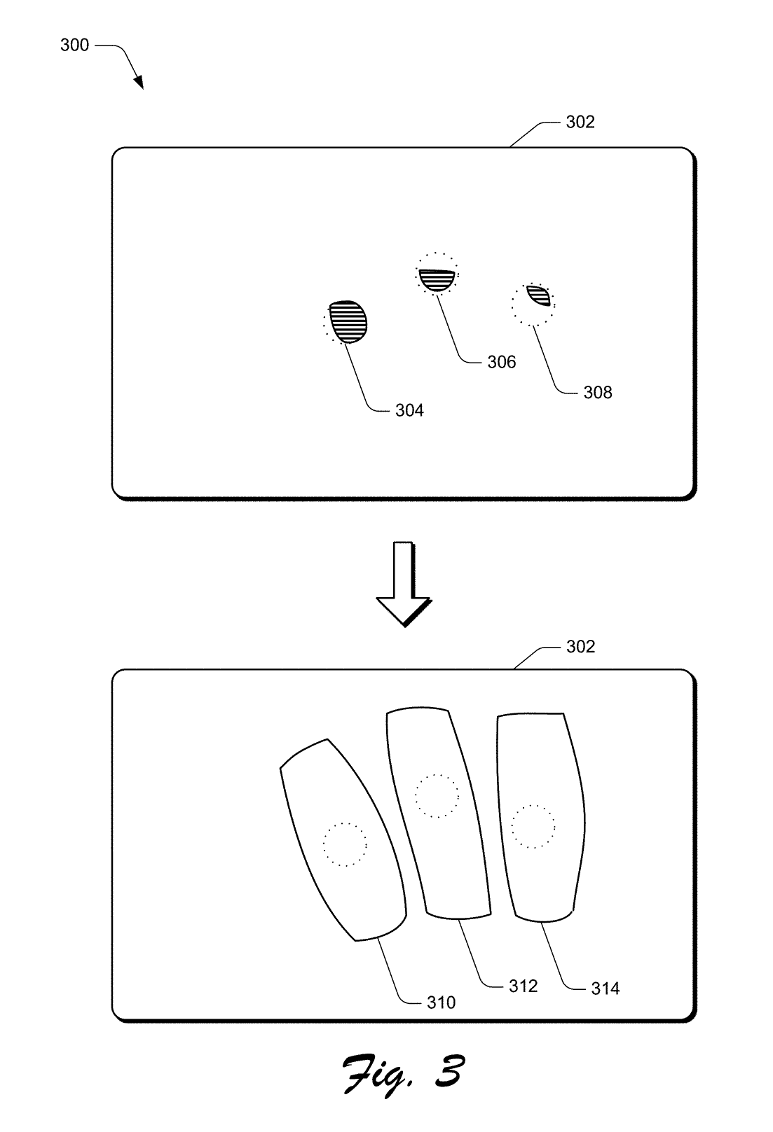

FIG. 3 depicts an example implementation scenario 300 for generating a multifinger keyboard based on received gesture input in accordance with one or more implementations. The scenario 300 is representative of functionality provided by the keyboard system 124, as introduced above. The input device 302 is representative of one or more of the input mechanisms 114, as illustrated in FIG. 1. For instance, the input device 302 may be implemented as the display device 110 of the client device 102 described above. In some implementations, an input area for input device 302 is representative of a portion of one of the input mechanisms 114. For instance, the input device 302 may encompass the area indicated by the bounded region 118 of display device 110, as illustrated in FIG. 1. In this manner, a size and position of the input device 302 relative to an input mechanism 114 is determined based on detected input and dimensions of a user's hand, as described in further detail below. By dimensioning input device 302 to occupy a portion of an overall input area for input mechanism 114, input received at input mechanism 114 outside a corresponding area for input device 302 may be treated differently from input received at a multifinger keyboard. For instance, input received at an input mechanism 114, outside the input device 302, may be treated independently of, or complementary to, input received at a multifinger keyboard using the techniques described herein.

In the example implementation, an input device 302 is illustrated as receiving gesture input at inputs 304, 306, and 308. For example, shaded regions of the inputs 304, 306, and 308 are illustrated as representing contact points between a touch input surface and fingers of a user's hand. In the illustrated example, the dotted circles represent respective areas of the input device 302 that may be contacted by the fingers of the user's hand due to inadvertent fluctuations in finger position relative to the input device 302.

For instance, input 304 may be received from an index finger of a user's right hand, input 306 may be received from a middle finger of the user's right hand, and input 308 may be received from a ring finger of the user's right hand. The shaded regions of inputs 304, 306, and 308 represent areas of the input device 302 that are in contact with a user's hand, such as areas of contact between the display device 110 and hand 116 of FIG. 1. Thus, the inputs 304, 306, and 308 are representative of contact points between a user's hand and the input device 302 for a specific orientation between the input device and the user's hand.

Although described and illustrated with respect to a keyboard configured for right-hand operation, the techniques described herein can be implemented to generate a keyboard for any three fingers in both right and left-hand configurations. Furthermore, although described and illustrated with respect to contact points at a touch input surface, inputs 304, 306, and 308 are representative of a variety of input types that can be detected by the input mechanisms 114 of FIG. 1, including proximity points based on distance detection from an input surface, camera information describing distance and orientations of a user's fingers, pressure sensitive input values, and so forth.

In the example implementation, the input device 302 is illustrated as receiving a three-finger tap based on near-simultaneous inputs from three fingers of a user's hand, as indicated by the inputs 304, 306, and 308. Although illustrated and described as a three-finger tap gesture, any variety of inputs may be used to initiate generation of a multifinger keyboard, such as a double tap, a swipe, and so forth. In some implementations, the keyboard system 124 enables user selection of an input that can be received at one of the input mechanisms 114 that will be recognized as a request to generate a multifinger keyboard.

In order to generate individual keys of a multifinger keyboard in a manner that are automatically aligned with a present position of the user's fingers, the keyboard system 124 determines an input location and an input profile for each of the inputs 304, 306, and 308. The input location may be described as a pixel address, a set of Cartesian coordinates, and so forth. Alternatively or additionally, the input location may be described as a set of pixels, an area of an input device surface, and so forth. Thus, the keyboard system 124 is able to determine a present location of each finger to be used in operating the multifinger keyboard.

The keyboard system additionally determines an input profile for each of the fingers corresponding to inputs 304, 306, and 308. An input profile may be described as a set of pixels, an area of an input device surface, and so forth. In some implementations, an input profile is compared against a database storing information that correlates different input profiles with different extension positions of a finger. For instance, an input profile for an index finger progressively changes during a flick down gesture, where the index finger is dragged from an initial extended position to a final position where the finger is retracted towards the wrist. In some implementations, a finger's present position describes a degree of extension or a degree of flexion of each knuckle of the finger.

Thus, the keyboard system 124 is able to determine a present position for each finger based on respective input profiles for inputs 304, 306, and 308. In this manner, the keyboard system 124 determines a specific finger used to generate an input, such as by determining that input 306 is generated with a middle finger of a right hand. Based on information describing a present position, a size, and a specific finger for each finger involved in generating input 304, input 306, and input 308, the keyboard system 124 can determine an estimated reach for each finger relative to the input positions for inputs 304, 306, and 308. Consequently, the keyboard system 124 determines an estimated range of motion for each finger involved in generating inputs 304, 306, and 308, relative to the input position for the finger.

For instance, the keyboard system 124 determines a maximum reach that can be accomplished through a full extension of the finger and a minimum reach that can be accomplished through a full flexion of the finger, with minimal radial and/or ulnar deviation. As described herein, a finger's extension increases as the fingertip moves from a closed first position to a position where the fingertip is pointing away from the palm. Conversely, a finger's flexion increases as a fingertip moves from pointing away from the palm to a closed first position. Radial and ulnar deviation consequently refer to motion that is generally perpendicular to a fingertip's path of travel during extension and flexion.

Using this information, the multifinger keyboard system 124 generates a multifinger keyboard, represented as including keys 310, 312, and 312 in the second instance of input device 302. In the illustrated example, key 310 is dimensioned and positioned based on the received input 304. Likewise, key 312 is dimensioned and positioned based on the received input 306 and key 312 is dimensioned and positioned based on the received input 308.

As illustrated, a shape of each key 310, 312, and 314 is not restricted to any geometric shape, and each key 310, 312, and 314 may vary in size relative to one another. Although not illustrated, individual keys may overlap with adjacent keys in some implementations. Accordingly, the keyboard system 124 is configured to generate different sized keys that are customized based on a current size and position of fingers used to generate inputs. In the illustrated example, key 310 is dimensioned and positioned for an index finger of a right hand, key 312 is dimensioned and positioned for a middle finger of a right hand, based and key 314 is dimensioned and positioned for a ring finger of a right hand.

A multifinger keyboard is thus dimensioned to account for how a user's fingers would move while providing inputs to the keyboard in a manner that does not require lateral finger movement (e.g., radial or ulnar movement). In some implementations, such as where the input device 302 is configured as the display device 110 of FIG. 1, input boundaries are displayed to visually describe a shape and size of individual keys. For example, the input device 302 may display the freeform shapes of keys 310, 312, and 314 as illustrated. Alternatively, the generated keys 310, 312, and 314 are not displayed, such that there is no visual indication as to a shape, size, or position of keys 310, 312, and 314, relative to an input area of the input device 302. Thus, in at least one implementation, the depiction of the keys 310, 312, and 314 presented in the scenario 300 represents a logical representation of the area of the keys, and not a visually displayed depiction of the keys.

A shape, size, and position of each key 310, 312, and 314 can be further determined based on a device type of the input device 302. For instance, the keyboard system 124 determines a size, a shape, and a device type for the input device 302. In this manner, the keyboard system 124 is able to identify whether the input device 302 is a tablet touchscreen, is a laptop trackpad, is a touch-sensitive fabric integrated into a pair of pants, is a camera, and so forth. From this information, the keyboard system 124 determines an estimated range of motion for each finger used to generate inputs 304, 306, and 308, and generates keys 310, 312, and 314 accordingly. As such, visual displays and/or logical generation of keyboard keys generated using the techniques described herein may vary widely among different users and different device types.

In some implementations, the generating module 126 generates the keys 310, 312, and 314 based on historical user information. For instance, the keyboard system 124 may generate a model that describes an average range of movement for a designated finger, relative to a detected input profile based on monitored user inputs. In some implementations, a user identifier is determined for a user of the device implementing the keyboard system 124, such as the client device 102. This enables the keyboard system 124 to generate key 310 based on a model describing historical motion associated with a particular user's right index finger, in response to detecting that a right index finger was used to generate input 304. In this manner, the keyboard system 124 further tailors the keys 310, 312, and 314 of the multifinger keyboard to an individual user.

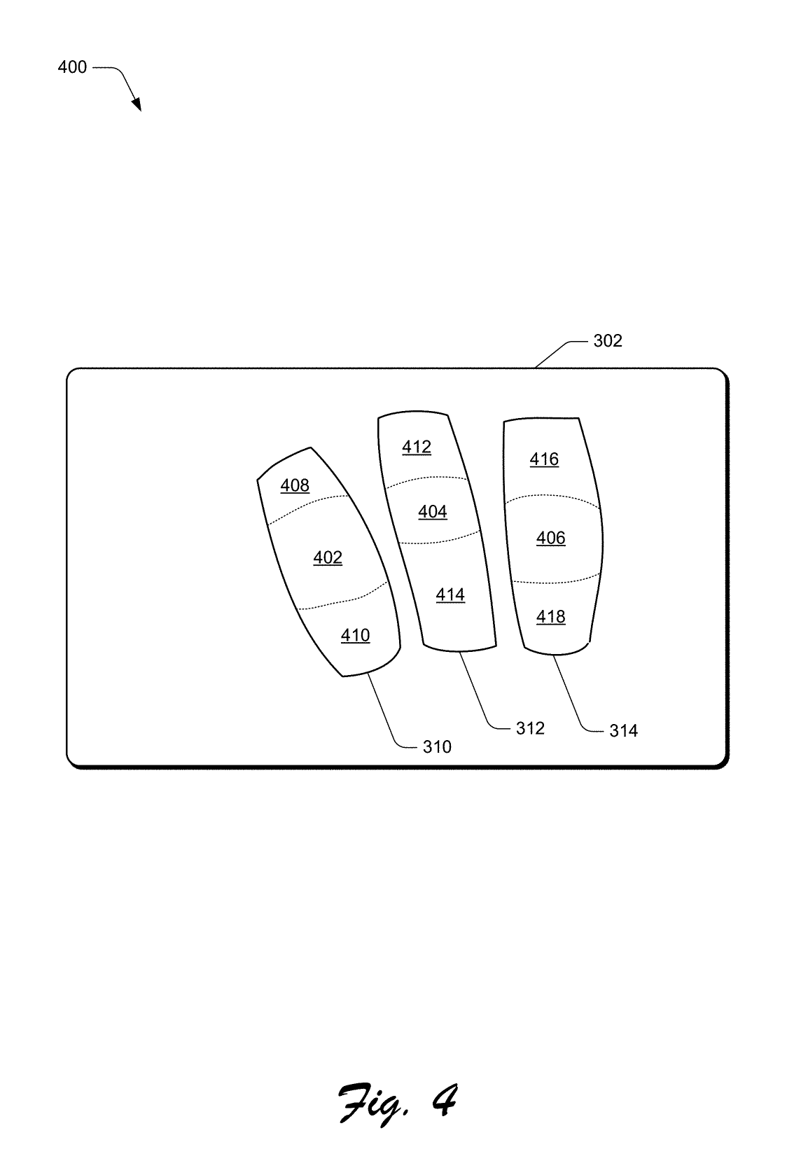

FIG. 4 depicts an example implementation scenario 400 for generating different input zones for keys of a multifinger keyboard based on received gesture input in accordance with one or more implementations. The scenario 400 is representative of functionality provided by the keyboard system 124, as introduced above.

In the example implementation, key 310 includes input zone 402, which is generally positioned relative to the input device 302 based on an input location of the input 304 of FIG. 3. Likewise, key 312 includes input zone 404, which is generally positioned relative to the input device 302 based on an input location of the input 306 of FIG. 3. Key 314 includes input zone 406, which is generally positioned relative to the input device 302 based on an input location of the input 308 of FIG. 3. Thus, in the illustrated example, the keys 310, 312, and 314 of the multifinger keyboard are dimensioned and positioned for an index, middle, and ring finger of a user's right hand, where each finger is approximately equidistant from a full extension position and a full flexion position.

In the illustrated example, key 310 is generated to include additional input zones 408 and 410. Likewise, key 312 includes input zones 412 and 414, and key 314 includes input zones 416 and 418. In at least one implementation, the illustrated example presumes that each finger is approximately equidistant from a full extension position and a full flexion position, and thus the different input zones represent areas of each key 310, 312, and 314 that are likely to be activated via available finger movements that includes minimal radial and ulnar motion. For instance, the input zones 408, 412, and 416 represent estimated areas of respective keys 310, 312, and 314 that are likely to be activated by inputs that involve extension of the finger relative to a starting position. Example inputs that involve finger extension include a swipe up gesture, a flick gesture, a tap up input, and so forth.

Conversely, the input zones 410, 414, and 418 represent estimated areas of respective keys 310, 312, and 314 that are likely to be activated by inputs that involve flexion of the finger relative to a starting position. Example inputs that involve finger flexion include a swipe down gesture, a flick down gesture, a tap down input, and so forth. Thus, each key 310, 312, and 314 of the multifinger keyboard includes multiple input zones that can be activated by a finger without requiring radial or ulnar motion.

Accordingly, each input zone 402, 404, 418 is dimensioned and positioned to account for an available range of motion of a finger relative to an initial input location, as described above. Furthermore, each input zone is dimensioned to account for variations in drift that occur during user input. Thus, each input zone is not restricted to a particular geometric shape and may vary in size, dimensions, and position based on the input location, the input profile, and the input device type, as above. Accordingly, a visual appearance of input zones can vary widely among different keys and different users when generated using the techniques described herein.

Although illustrated and described with respect to an implementation where each key 310, 312, and 314 includes three different input zones, the keyboard system 124 can generate a multifinger keyboard 204 such that each key includes any number of input zones. Additionally or alternatively, a number of input zones included in the key 310 may differ from a number of input zones included in one or more of the keys 312 and 314. In some implementations, a number of input zones included in each key of a multifinger keyboard is based on a particular finger for which the key is generated. For instance, a key generated for an index finger may include more input zones than a key generated for a pinky finger, due to a respective difference in general relative dexterity of the fingers. Alternatively or additionally, the input zones may be dimensioned and positioned based on historical user input. For instance, the keyboard system 124 may generate an input zone based on a model describing historical motion associated with a particular user's right index finger, in response to detecting that a right index finger is to be used for a multifinger keyboard. In this manner, the keyboard system 124 customizes input zones of the keys 310, 312, and 314 for an individual user.

Tables 1-3 are representative of different input configurations for a multifinger keyboard, which are each associated with one or more output values for each input zone of the multifinger keyboard, as illustrated in FIG. 4.

TABLE 1
Key 310

Input Configuration

| | Zone 408 | Zone 402 | Zone 410 |
|---|---|---|---|
| Cursor Control | Left Click | Null | Right Click |
| Alpha Numeric | J K L 7 | A B C 4 | S T 1 0 |
| Game Controller | Left | Null | Right |

TABLE 2
Key 312

Input Configuration

| | Zone 412 | Zone 404 | Zone 414 |
|---|---|---|---|
| Cursor Control | Move Up | Null | Move Down |
| Alpha Numeric | M N O 8 | D E F 5 | U V W 2 |
| Game Controller | Gas | Null | Brake |

TABLE 3
Key 314

Input Configuration

| | Zone 416 | Zone 406 | Zone 418 |
|---|---|---|---|
| Cursor Control | Move Left | Null | Move Right |
| Alpha Numeric | P Q R 9 | G H I 6 | X Y Z 3 |
| Game Controller | Horn | Null | Look Back |

For instance, in an example implementation where the multifinger keyboard is configured for cursor control, each input zone 402, 404, . . . 418 may be associated with a single output value. In this example implementation, key 310 is configured for selection command outputs, such that input zone 408 is associated with a left click command, input zone 402 is associated with a null command, and input zone 410 is associated with a right click command. Key 312 is configured for vertical cursor control, such that input zone 412 is associated with a move up command, input zone 404 is associated with a null command, and input zone 415 is associated with a move down command. Key 314 is configured for horizontal cursor control, such that input zone 416 is associated with a move left command, input zone 406 is associated with a null command, and input zone 418 is associated with a move right command. Thus, based on simultaneous input to various input zones of keys 310, 312, and 314, multiple outputs can be generated to control functionality of a computing device through cursor operations.

Alternatively or additionally, individual input zones 402, 404, . . . 418 can be associated with multiple output values. For instance, in an example implementation where the multifinger keyboard is configured for alpha numeric input, the input zones 402, 404, . . . 418 are each associated with multiple output values corresponding to letters of an alphabet, numbers, symbols, and the like. In this manner, the multifinger keyboard can be used to generate output values for any language. For instance, in an example alpha numeric configuration for the English language, input zone 408 is associated with “J”, “K”, “L”, and “7” output values, input zone 402 is associated with “A”, “B”, “C”, and “4” output values, and input zone 410 is associated with “S”, “T”, “1”, and “0” output values. Input zone 412 is associated with “M”, “N”, “O”, and “8” output values, input zone 404 is associated with “D”, “E”, “F”, and “5” output values, and input zone 414 is associated with “U”, “V”, “W”, and “2” output values. Similarly, input zone 416 is associated with “P”, “Q”, “R”, and “9” output values, input zone 406 is associated with “G”, “H”, “I”, and “6” output values, and input zone 418 is associated with “X”, “Y”, “Z”, and “3” output values. In this example configuration, output values “A”, “E”, and “I” are associated with input zones 402, 404, and 406, respectively, to provide ergonomic comfort for selecting these frequently used vowels. Thus, multiple potential outputs can be generated to produce alpha numeric letters and symbols.

In some implementations, different output values are associated with different input types. For instance, continuing the English alpha numeric example, a single tap at input zone 408 may correspond to a “1” output value, while a double tap may correspond to a “0” value. Thus, the keyboard system 124 determines potential outputs from input received at the multifinger keyboard based on at least one of an input zone at which the input received or an input type of the received input. In this manner, the multifinger keyboard can be configured to support output values for any range of applications, such as word processing, gaming, cursor control, and so forth. In order to determine a final output based on input received at the multifinger keyboard, some implementations disambiguate potential outputs based on an input configuration of the multifinger keyboard.

For instance, consider an example scenario where concurrent input is detected at input zones 410, 412, and 406 when the multifinger keyboard of FIG. 4 is configured for English alpha numeric input. In this example scenario, potential outputs that can be generated from various combinations of the output values “P”, “Q”, “R”, “S”, “7”, “A”, “B”, “C”, “2”, “M”, “N”, “O”, and “6”, assuming that the input zones are configured as indicated in Tables 1-3 above. For instance, potential outputs from concurrent inputs to input zones 410, 412, and 406 include “ARM” and “MAP”. Thus, the disambiguation module 130 of FIG. 1 is configured to generate a final output from these potential outputs. As described herein, disambiguation can be performed based on various information, such as a context for a word relative to a corresponding sentence or paragraph, dictionary information describing a frequency of word use, historical user information, information indicating a user selection, and so forth. Continuing the example scenario, the disambiguation module 130 may recognize that a final output is to be used in the context of an anatomy textbook and generate “ARM” as the final output instead of “MAP”, based on this context.

In some implementations, respective sizes of the different input zones 402, 404, . . . 418 are updated while a user interacts with the keys 310, 312, and 314 of the multifinger keyboard. For instance, if the keyboard system 124 determines that a user continues to strike an area represented by the dotted line separating input zones 408 and 402 during a tap up input, the input zone 408 may be resized to encroach on an area illustrated as occupied by the input zone 402. In this manner, the keyboard system 124 continuously updates positions and dimensions of input zones to provide reliable targeting.

Accordingly, techniques described herein enable generation of a multifinger keyboard that adapts to a variety of input configurations and output values for use in interacting with a variety of applications. Ranges of input configurations and output values can further be expanded through the addition of an auxiliary key to the multifinger keyboard.

FIG. 5 depicts an example implementation scenario 500 for generating an auxiliary key for a multifinger keyboard in accordance with one or more implementations. The scenario 500 is representative of functionality provided by the keyboard system 124, as introduced above.

In the example implementation, input device 302 is illustrated as including keys 310, 312, and 314 of a multifinger keyboard generated using the techniques described herein. Input device 302 is further illustrated as receiving input 502. For example, input 502 may be received from a thumb of a user's right hand, continuing the example where keys 310, 312, and 314 are generated for an index, a middle, and a ring finger of a right hand, respectively. In some implementations, input 502 is received as a pre-defined gesture, such as a double tap, that is recognizable by the keyboard system 124 to generate an auxiliary key. Any variety of input types may be used to generate an auxiliary key for the multifinger keyboard, and is in some implementations defined by a user of the computing device implementing the keyboard system 124.

In order to generate an auxiliary key in a manner that is automatically aligned with a present position of the user's thumb, the keyboard system 124 determines an input location and an input profile for the input 502. The input location may be described as a pixel address, a set of Cartesian coordinates, and so forth. Alternatively or additionally, the input location may be described as a set of pixels, an area of an input device surface, and so forth. Thus, the keyboard system 124 is able to determine a present location of the finger to be used in operating the auxiliary key for the multifinger keyboard.

The keyboard system additionally determines an input profile for the finger used to generate input 502. An input profile may be described as a set of pixels, an area of an input device surface, and so forth. In some implementations, an input profile is compared against a database storing information that correlates different input profiles with different extension positions of a finger. For instance, an input profile for a thumb progressively changes as a thumb is dragged from an initial extended position to a final position where the thumb is retracted towards the palm. In some implementations, a finger's present position describes a degree of extension or a degree of flexion of each knuckle of the finger.

Thus, the keyboard system 124 is able to determine a present location and position relative to the input device 302 for the finger that generated input 502. In this manner, the keyboard system 124 can further determine a specific finger used to generate an input, such as to identify that input 502 was generated with a thumb of a right hand. Based on information describing a present position and a specific finger involved in generating input 502, the keyboard system 124 determines an estimated reach for the finger. Consequently, the keyboard system 124 determines an estimated range of motion relative to an input position for a finger.

For instance, an auxiliary key 504 is generated such that it is positioned and dimensioned relative to the input device 302 based on the input 502. A shape and size of the auxiliary key 504 is not restricted to any geometric shape or size and may overlap with at least part of one or more of keys 310, 312, and 314. Similar to the keys 310, 312, and 314 described above, the auxiliary key 504 is thus generated to include an estimated range of motion for the finger used to generate input 502, based on an input location, input profile, and device type of the input device 302. Similar to the keys 310, 312, and 314, an input area of the auxiliary key 504 is optionally displayable on one or more of the input device 302 and/or a connected display device.

Auxiliary key 504 is illustrated as including input zones 506, 508, and 510. Input zone 506 is generally positioned relative to the input device 302 based on an input location of the input 502. Thus, in the illustrated example, the auxiliary key 504 is positioned and dimensioned for a thumb of a user's right hand, where input 502 was received when the thumb is approximately equidistant from a full extension position and a full flexion position while a user's right hand is resting on input device 302. Accordingly, input zone 508 is generated to encompass an area that is likely to be activated by inputs that require extension of the thumb, such as a swipe out gesture, a flick gesture, a tap out input, and so forth. Further, input zone 510 is dimensioned and positioned to encompass an area that is likely to be activated by inputs that require flexion of the thumb, such as a swipe in gesture, a flick down gesture, a tap in gesture, and so forth.

Each input zone 506, 508, and 510 is dimensioned and positioned to account for an available range of motion of a finger relative to an initial input location as described above. Furthermore, each input zone is dimensioned to account for variations in drift that occur during user input. Thus, each input zone is not restricted to a particular geometric shape and may vary in size, dimensions, and position based on the input location, the input profile, and the input device type, as above. Accordingly, a visual appearance of input zones can vary widely among different keys and different users when generated using the techniques described herein.

Respective output values associated with different input zones 506, 508, and 510 can vary based on an input configuration of the multifinger keyboard. In some implementations, each input zone is associated with a single output value. Alternatively or additionally, one or more input zones can each be associated with multiple output values. Furthermore, different output values can be associated with different input types, such that different inputs to a single input zone will result in different outputs. In some implementations, output values associated with the input zones 506, 508, and 510 can be used to modify or select input value associated with the input zones 402, 404, . . . 418 of the keys 310, 312, and 314. For instance, in an alpha numeric configuration, input zone 506 can be associated with a shift command, input zone 508 can be associated with a command to switch input configurations, and input zone 510 can be associated with a space command.

Thus, in at least one implementation, the keyboard system 124 determines potential outputs based on inputs received at the auxiliary key 504, in combination with inputs received at the keys 310, 312, and 314. In this manner, the multifinger keyboard can be configured with an optional auxiliary key to support output values for any range of applications, such as word processing, gaming, cursor control, and so forth. In order to determine a final output based on input received at the multifinger keyboard, some implementations disambiguate potential outputs based on an input configuration of the multifinger keyboard and inputs received at keys 310, 312, 314, and 504, as discussed in further detail below.

FIG. 6 depicts an example implementation scenario 600 for generating a final output by disambiguating among multiple potential outputs based on input received at a multifinger keyboard. The scenario 600 is representative of functionality provided by the keyboard system 124, as introduced above.

In the example implementation, input is received at the keys 310, 312, and 314 via the input device 302. For instance, input received at the input zone 402 of key 310 is associated with an apple output value, input received at the input zone 414 of key 312 is associated with a donut output value, and input received at the input zone 416 of key 314 is associated with a grape output value. In some implementations, the apple, donut, and grape output values are each representative of one of multiple output values associated with each of the respective input zones 402, 414, and 416. The output values associated with respective keys 310, 312, and 314 are thus determined based on an input type and an input zone, and are representative of any one or more output values that are defined based on an input configuration of the multifinger keyboard. The monitoring module 128, for instance, monitors for keyboard input 206 to the multifinger keyboard 204, in order to generate one or more potential outputs 208, which are represented in the example implementation as potential outputs 602, 604, 606, 608, 610, and 612. In some implementations, a number of generated potential outputs 602, 604, . . . 612 is increased when input is detected at auxiliary key 614. Accordingly, a number of the generated potential outputs 602, 604, . . . 612 varies based on a number of input zones involved with a given input or sequence of inputs to the multifinger keyboard. Likewise, a number of generated potential outputs 602, 604, . . . 612 varies based on a number of output values associated with a given input zone involved with an input or sequence of inputs to the multifinger keyboard.

Although the generated potential outputs 602, 604, . . . 612 are illustrated as including a different sequence of output values associated with keys 310, 312, and 314, the potential outputs 208 may alternatively or additionally include outputs generated from a combination of output values associated with keys 310, 312, and 314. For example, the apple output value, donut output value, and grape output value may be combined to generate a potential output 208 that includes a single apple and a grape flavored donut, a potential output 208 that includes an apple fritter with grape jelly, and so forth. Thus, the potential outputs 208 may include a derivative output that is generated as a product of two or more output values, in addition to potential outputs that are generated as an ordered combination of output values.

Because the monitoring module 128 is configured to generate a final output based on concurrent or near-concurrent input to different input zones of the multifinger keyboard, the disambiguation module 130 is configured to generate a final output 616 from the potential outputs 602, 604, . . . 612. In some implementations, a number of the potential outputs 602, 604, . . . 612 that are considered for use in generating the final output 616 is filtered based on an input configuration of the multifinger keyboard. For instance, in an alpha numeric configuration, the final output 616 may be compared against a dictionary that includes information describing a frequency with which a word is used in a given language. In this example, the potential outputs 602, 604, . . . 612 include potential words that can be generated based on simultaneous input to the keys 310, 312, and 314.

The disambiguation module 130 then selects the three most frequently used words from the potential outputs 602, 604, . . . 612 to generate the final output 616. In some implementations, the disambiguation module 130 causes display of potential outputs 602, 604, . . . 612 to enable user selection of the final output 616. Alternatively or additionally, the potential outputs can be filtered based on historical user information, such as information describing how frequently a certain user generates certain outputs. For instance, the disambiguation module 130 may identify that potential outputs 602, 604, and 606 are most frequently generated by the multifinger keyboard for a given user and a given input configuration. The disambiguation module 130 may then visually display the potential outputs 602, 604, and 606 and prompt a user to select one for use as the final output 616. In some implementations, selection among potential outputs 602, 604, . . . 612 is performed via input to the auxiliary key 614. After generating the final output 616, the disambiguation module 130 communicates the final output 616 to a computing device implementing the keyboard system 124, such as client device 102.

Accordingly, techniques described herein enable generation of a wide variety of output values that can be implemented using a variety of input configurations for use in interacting with a variety of applications.

Having described some example implementation scenarios, consider now some example procedures for a multifinger keyboard in accordance with one or more implementations. Generally, the procedures may be implemented in the environment 100 described above, the system 1000 of FIG. 10, and/or any other suitable environment. The procedures, for example, describe example ways for implementing various aspects of the scenarios described above. In at least some implementations, steps described for the various procedures are performed automatically and independent of user interaction.

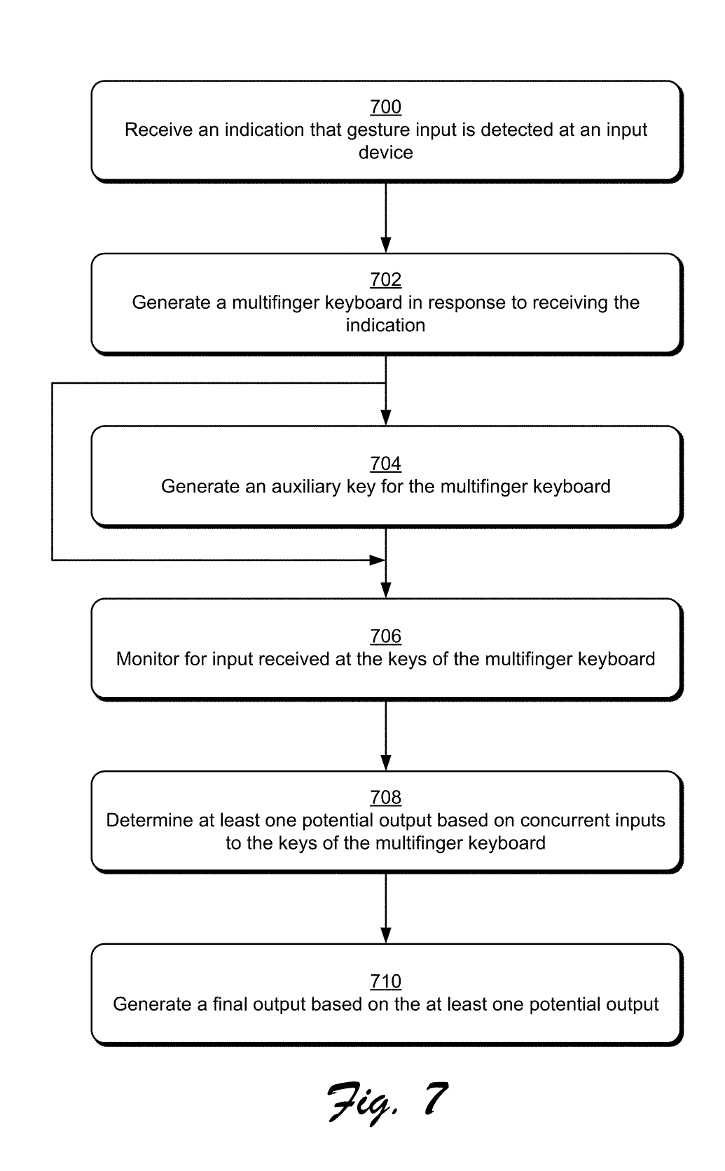

FIG. 7 is a flow diagram that describes steps in an example method for generating a multifinger keyboard based on gesture input in accordance with one or more implementations.

Step 700 receives an indication that a gesture input is detected at an input device. The generation module 126, for instance, receives an indication that gesture input is detected at an input mechanism 114 of client device 102. In some implementations, the gesture input may be a three-finger gesture input, as described herein and illustrated with respect to FIG. 3.

Step 702 generates a multifinger keyboard in response to receiving the indication. The generation module 126, for instance, generates the multifinger keyboard 204, as illustrated in FIG. 2. The multifinger keyboard is generated to include at least three different keys, such as keys 310, 312, and 314, which are each dimensioned and positioned based on a corresponding finger of a user's hand. Although illustrated and described herein with reference to a multifinger keyboard generated for three-adjacent fingers of a user's right hand, a multifinger keyboard can be generated for any three fingers and in both right and left-handed configurations. Generating individual keys of the multifinger keyboard additionally includes defining at least three different input zones for each key, which are in turn each dimensioned and positioned based on an available reach for the corresponding finger.

Step 704 generates an auxiliary key for the multifinger keyboard. Step 704 is optionally performed, as indicated by the arrow circumventing step 704. The generation module 126, for instance, generates the auxiliary key 504 in response to detecting an additional input 502, proximal to the multifinger keyboard. A position and dimensions of the auxiliary key for multifinger keyboard are determined based on a corresponding finger of a user's hand. For instance, the auxiliary key 504 is illustrated and described as being dimensioned and positioned to provide a key for a user's right hand thumb while using keys 310, 312, and 314 of FIG. 5's right-handed multifinger keyboard. Generating the auxiliary key for the multifinger keyboard further includes defining at least three different input zones that are each dimensioned and positioned based on an available reach of the finger for which the auxiliary key was generated.

Step 706 monitors for input received at the keys of the multifinger keyboard. The monitoring module 128, for instance, monitors for keyboard input 206 received at the multifinger keyboard 204. Monitoring for input received at the multifinger keyboard includes differentiating among different input types received at a given input zone. For instance, the monitoring module 128 can distinguish between a “tap” input and a “swipe-up” input received at input zone 406, as illustrated in FIG. 4. The monitoring module 128 is configured to simultaneously monitor for inputs at each key of the individual keyboard, such that an output can be determined from concurrent inputs among the different keys of the multifinger keyboard.

Step 708 determines at least one potential output based on concurrent inputs to the keys of the keyboard. The monitoring module 128, for instance, generates at least one potential output 208 based on the keyboard input 206 received at the multifinger keyboard. As illustrated and described with respect to FIG. 6, because the at least one potential output is based on concurrent inputs relative to the multifinger keyboard, a single instance of concurrent inputs may result in different potential outputs.

Step 710 generates a final output based on the at least one potential output. The disambiguation module 130, for instance, disambiguates the potential outputs 208 to generate the output 210. The disambiguation module 130 is configured to disambiguate potential outputs 208 based on an input configuration of the multifinger keyboard, as illustrated and described with respect to FIG. 4. In some implementations, disambiguation is performed using dictionaries for alpha-numeric inputs. Alternatively or additionally, disambiguation is performed based on historical user inputs, such that the disambiguation model 130 selects a potential output for use as the final output based on a given user's historical input tendencies. In some implementations, a set of top-candidate potential outputs are displayed for user selection or confirmation that a certain predicted output is to be used as the final output. In implementations where a set of top-candidate potential outputs are displayed for user selection, user selection may be performed using the multifinger keyboard, using techniques described herein. The disambiguation model then generates the final output 210 and communicates the final output to a computing device, such as client device 102 of FIG. 1.

Thus, FIG. 7 describes a general procedure for generating a multifinger keyboard based on received gesture input and monitoring the multifinger keyboard for received inputs to generate a final output. In implementations, the operations of FIG. 7 can be performed by a computing device implementing the keyboard system 124, such as the client device 102 of FIG. 1.

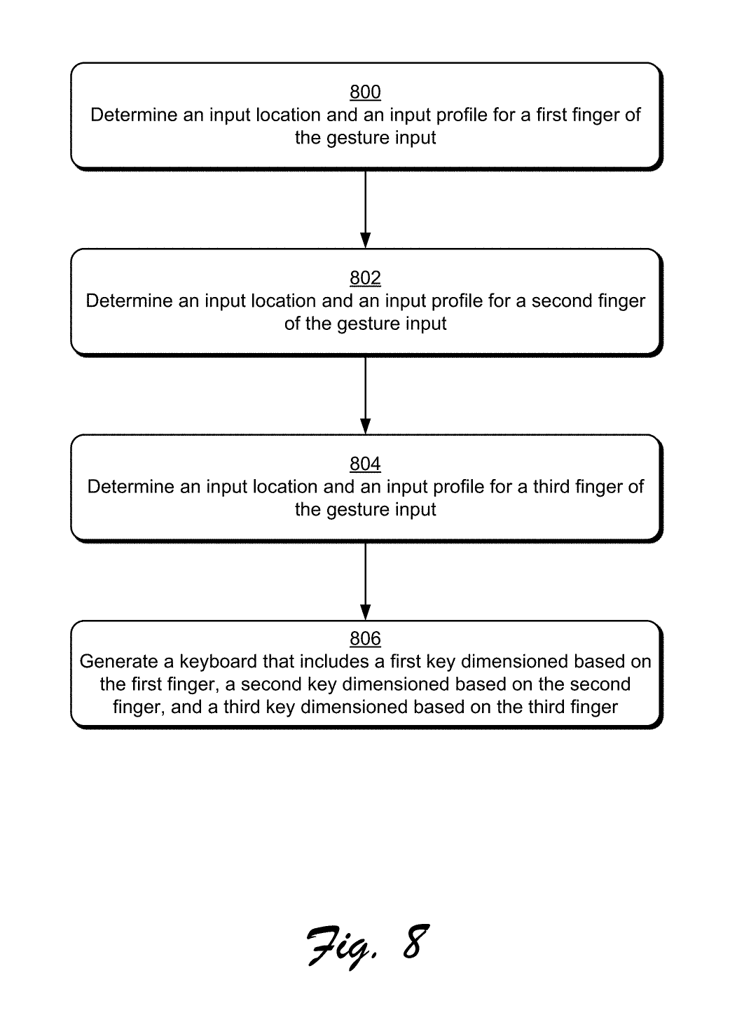

FIG. 8 is a flow diagram that describes steps in a method for generating a multifinger keyboard based on received gesture input in accordance with one or more implementations. In at least one implementation, the flow diagram of FIG. 8 represents a way of performing step 702 of FIG. 7.

Step 800 determines an input location and an input profile for a first finger of a received gesture input. The generation module 126, for instance, may determine that a first finger of the gesture input 202 is received as input 304. The generation module 126 then proceeds to determine a location for the input 304 relative to an input device 302 at which the input was received. The generation module 126 additionally determines an input profile for the input 304, which is useable to ascertain an estimated position of the first finger, such as a degree to which the first finger is extended from a closed first position. In some implementations, an input profile for the first finger can be compared to input profiles for second and third fingers to determine a current position and orientation of the first finger. Alternatively or additionally, the position and orientation of the first finger is determined based on a current position and orientation of a user's wrist and forearm with respect to an input device.

Step 802 determines an input location and an input profile for a second finger of the received gesture input. The generation module 126, for instance, may determine that a second finger of the gesture input 202 is received as input 306. The generation module 126 then proceeds to determine a location for the input 306 relative to an input device 302 at which the input was received. The generation module 126 additionally determines an input profile for the input 306, which is useable to ascertain an estimated position of the second finger, such as a degree to which the second finger is extended from a closed fist position. In some implementations, the input profile for the second finger can be compared to input profiles for the first finger and a third finger to determine a current position and orientation of the second finger. Alternatively or additionally, the position and orientation of the second finger is determined based on a current position and orientation of a user's wrist and forearm with respect to an input device.

Step 804 determines an input location and an input profile for a third finger of the received gesture input. The generation module 126, for instance, may determine that a third finger of the gesture input 202 is received as input 308. The generation module 126 then proceeds to determine a location for the input 308 relative to an input device 302 at which the input was received. The generation module 126 additionally determines an input profile for the input 308, which is useable to ascertain an estimated position of the third finger, such as a degree to which the third finger is extended from a closed fist position. In some implementations, an input profile for the third finger can be compared to input profiles for the first and second fingers to determine a current position and orientation of the third finger. Alternatively or additionally, the position and orientation of the third finger is determined based on a current position and orientation of a user's wrist and forearm with respect to an input device.

Step 806 generates a keyboard that includes a first key dimensioned based on the first finger, a second key dimensioned based on the second finger, and a third key dimensioned based on the third finger. The generation module 126, for instance, generates the multifinger keyboard 204, as illustrated in FIG. 2. The multifinger keyboard is generated to include at least three different keys, such as keys 310, 312, and 314, which are each dimensioned and positioned based on the respective finger for which the key was generated. Generating individual keys of the multifinger keyboard additionally includes defining at least three different input zones for each key, which are in turn each dimensioned and positioned based on an available reach for the corresponding finger.

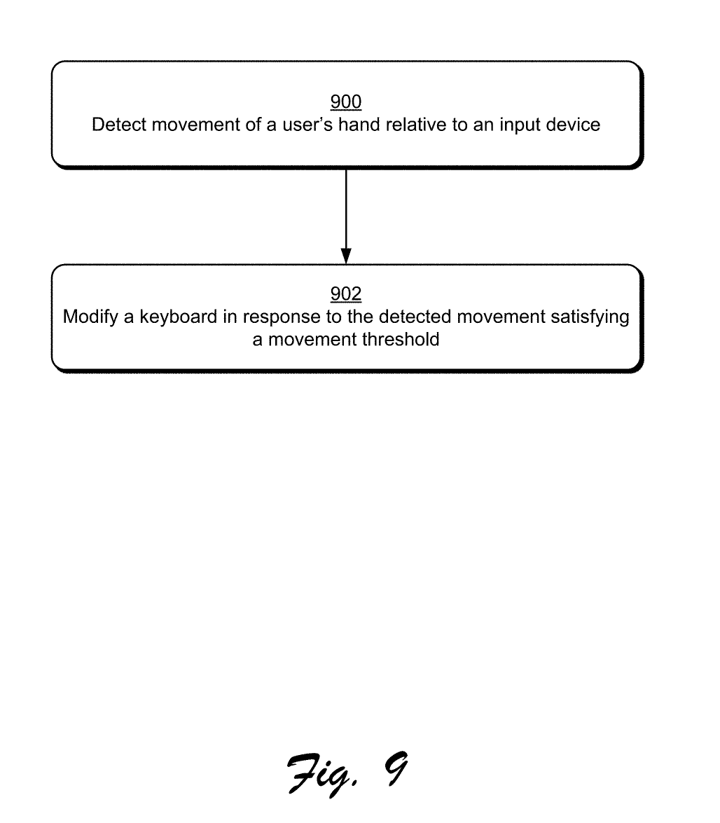

FIG. 9 is a flow diagram that describes steps in a method for a modifying a keyboard based on detected movement in accordance with one or more implementations. In at least one implementation, the flow diagram of FIG. 9 represents a way of performing step 706 of FIG. 7.

Step 900 detects movement of a user's hand relative to an input device. The monitoring module 128, for instance, monitors movement of the user's hand 116 relative to the display device 110 during input to the keyboard illustrated in the bounded region 118. In at least one implementation, detecting movement of the user's hand is based on the hand's detected movement relative to one or more keys or input zones of the keyboard, as described herein.

Step 902 modifies a keyboard in response to the detected movement satisfying a movement threshold. The monitoring module 128, for instance, compares the monitored movement to a threshold specifying a range of movement relative to original input positions for individual fingers of a user's hand. In some implementations, the movement threshold is defined relative to one or more keys or input zones of the keyboard. For instance, a movement threshold for a given finger may designate an area of movement relative to an initial input position for the finger such that the movement threshold is satisfied if the finger drifts outside an input area for a corresponding key of the keyboard. In this example, the bounded regions of keys 310, 312, and 314 of FIG. 3 are representative of ranges of movement for respective fingers that do not satisfy the movement threshold.

In some implementations, a movement threshold is satisfied in response to detecting that fingers of a user's hand are no longer in contact with the input device, and modifying the keyboard includes returning to step 700 of FIG. 7 to generate a new keyboard when the fingers are subsequently detected by the input device. The monitoring module 128, for instance, may send the liftoff notification 212 to the generation module 126 to cause the generation module 126 to generate a new instance of the multifinger keyboard 204. Alternatively or additionally, modifying the keyboard refers to modifying respective positions of one or more of the input zones 402, 404 . . . 418, as illustrated in FIG. 4.

Thus, the keyboard system 124 regenerates the keyboard as necessary to provide reliable targeting, even if a user's fingers change orientation, without requiring the user to look at the keyboard or otherwise orient to conform with a rigid keyboard structure.

In response to determining that the finger remains within the input area for the corresponding key, the monitoring module 128 does not send a liftoff notification 212 to the generation module 126 and continues to monitor for keyboard inputs 206, as indicated at step 812.

Having described some example implementation details, consider now a discussion of an example system and device in accordance with one or more implementations.

FIG. 10 illustrates an example system generally at 1000 that includes an example computing device 1002 that is representative of one or more computing systems and/or devices that may implement various techniques described herein. For example, the client device 102 discussed above with reference to FIG. 1 can be embodied as the computing device 1002. The computing device 1002 may be, for example, a server of a service provider, a device associated with the client (e.g., a client device), an on-chip system, and/or any other suitable computing device or computing system.

The example computing device 1002 as illustrated includes a processing system 1004, one or more computer-readable media 1006, and one or more Input/Output (I/O) Interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), motion functionality (e.g., accelerometers or other sensors that are configured to detect physical motion), a camera (e.g., which may employ visible or non-visible wavelengths such as infrared frequencies to detect movement that does not involve touch as gestures), six degrees of freedom controllers such as used in virtual reality and augmented reality technologies, and so forth. Examples of output devices include a display device (e.g., a monitor or projector), speakers, a printer, a network card, tactile-response device, head mounted displays (e.g., for virtual reality and augmented reality applications), and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1010 and computer-readable media 1006 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules that are executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, portable music player, portable gaming device, a tablet computer, a wearable device (e.g., a watch, glasses, an article of clothing, etc.), a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. For example, functionalities discussed with reference to the client device 102 may be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

In the discussions herein, various different implementations are described. It is to be appreciated and understood that each implementation described herein can be used on its own or in connection with one or more other implementations described herein. Further aspects of the techniques discussed herein relate to one or more of the following implementations:

1. A system comprising: at least one processor; and one or more computer-readable storage media including instructions stored thereon that, responsive to execution by the at least one processor, cause the system to perform operations including: detecting a gesture input at an input device; generating, in response to detecting the gesture input, a multifinger keyboard that includes a first key, a second key, and a third key, the individual keys of the multifinger keyboard positioned and dimensioned relative to the input device based on the detected gesture input; monitoring the multifinger keyboard for inputs received at the input device relative to the first key, the second key, and the third key; determining at least one potential output based on the monitored inputs; and generating a final output based on the at least one potential output.

2. The system of example 1, wherein the gesture input comprises a gesture input performed with first, second, and third fingers of a hand.

3. The system of any of preceding examples 1 or 2, wherein the gesture input comprises a gesture input performed with first, second, and third fingers of a hand, wherein the first key is dimensioned and positioned relative to the input device based on an input location of the first finger, the second key is dimensioned and positioned relative to the input device based on an input location of the second finger, and the third key is dimensioned and positioned relative to the input device based on an input location of the third finger.

4. The system of any of preceding examples 1-3, wherein the gesture input comprises a gesture input performed with first, second, and third fingers of a hand, wherein the first key is dimensioned and positioned relative to the input device based on an input profile associated with the first finger, the second key is dimensioned and positioned relative to the input device based on an input profile associated with the second finger, and the third key is dimensioned and positioned relative to the input device based on an input profile associated with the third finger.

5. The system of any of preceding examples 1-4, wherein the gesture input comprises a gesture input performed with first, second, and third fingers of a hand, the operations further including determining, for each of the first, second, and third fingers, an estimated range of motion for the finger relative to an input location for the finger at the input device and the multifinger keyboard is generated based on the estimated range of motion.

6. The system of any of preceding examples 1-5, wherein the first key, the second key, and the third key are each dimensioned and positioned relative to the input device based on a device type of the input device.

7. The system of any of preceding examples 1-6, wherein the first, second, and third keys each include at least three different input zones that are individually associated with one or more output values.

8. The system of any of preceding examples 1-7, wherein the first, second, and third keys each include at least three different input zones that are individually associated with one or more output values, the one or more output values determined based on an input configuration of the multifinger keyboard.

9. The system of any of preceding examples 1-8, wherein the first, second, and third keys each include at least three different input zones that are individually associated with one or more output values, wherein a position and dimensions for each of the at least three different input zones are determined based on an input position and an input profile of a finger for which the first, second, or third key is generated.

10. The system of any of preceding examples 1-9, wherein the gesture input comprises a gesture input performed with first, second, and third fingers of a hand, the operations further comprising generating an auxiliary key for the three finger keyboard in response to detecting an input initiated by a fourth finger at the input device.

11. The system of any of preceding examples 1-10, the operations further comprising determining that a hand used to provide the monitored input has moved in position relative to the input device and generating a new instance of the multifinger keyboard that aligns with the repositioned hand.

12. A computer-implemented method, comprising: receiving an indication that a gesture input is detected at an input device; determining an input location and an input profile for each of a first, second, and third finger associated with the gesture input; generating a multifinger keyboard that includes first, second, and third keys, each of the keys dimensioned and positioned based on the input location and the input profile for each of the first, second, and third fingers associated with the gesture input; generating an auxiliary key for the multifinger keyboard in response to receiving an indication that an additional input is received at the input device outside an area encompassed by keys of the multifinger keyboard, the additional input generated by a fourth finger; and monitoring the first key, the second key, the third key, and the auxiliary key for input; and generating an output based on concurrent inputs to the auxiliary key and one or more of the first key, the second key, or the third key.

13. The computer-implemented method of example 12, wherein generating the output based on the concurrent inputs includes generating multiple potential outputs and the output is generated from the multiple potential outputs by disambiguating among the multiple potential outputs using a dictionary.

14. The computer-implemented method of any of preceding examples 12 or 13, wherein the first, second, third, and auxiliary keys each include at least three different input zones that are individually associated with one or more output values.

15. The computer-implemented method of any of preceding examples 12-14, wherein the first, second, third, and auxiliary keys each include at least three different input zones that are individually associated with one or more output values, each of the one or more output values being associated with a different input type, wherein generating the output is based on an input zone at which input is received and an input type of received input.

16. The computer-implemented method of any of preceding examples 12-15, further comprising detecting termination of contact between the input device and one or more of the first finger, the second finger, or the third finger and ending generation of the multifinger keyboard in response to the detection.

17. A computer-implemented method, comprising: detecting input from a first finger to an input zone of a first key in a multifinger keyboard; detecting input from a second finger to an input zone of a second key in the multifinger keyboard; detecting input from a third finger to an input zone of a third key in the multifinger keyboard; determining at least one output value associated with the input zone of the first key, at least one output value associated with the input zone of the second key, and at least one output value associated with the input zone of the second key; determining multiple potential outputs, the multiple potential outputs including potential combinations of the at least one output value associated with the input zones of the first, second, and third keys; and generating a final output from the multiple potential outputs.

18. The computer-implemented method of example 17, wherein the input from the first finger, the input from the second finger, and the input from the third finger are concurrently detected.

19. The computer-implemented method of any of preceding examples 17 or 18, the operations further comprising displaying a subset of the multiple potential outputs, wherein the final output is generated in response to user selection of one of the subset of the multiple potential outputs.

20. The computer-implemented method of any of preceding examples 17-19, wherein the at least one output value associated with the input zone of the first key, the at least one output value associated with the input zone of the second key, and the at least one output value associated with the input zone of the second key are determined based on an input configuration of the multifinger keyboard.

What is claimed is:

1. A system comprising:
at least one processor; and
one or more computer-readable storage media including instructions stored thereon that, responsive to execution by the at least one processor, cause the system to perform operations including:
detecting a gesture input at an input device;
generating, in response to detecting the gesture input, a multifinger keyboard that includes a first key, a second key, and a third key, the individual keys of the multifinger keyboard positioned and dimensioned relative to the input device based on the detected gesture input;
monitoring the multifinger keyboard for inputs received at the input device relative to the first key, the second key, and the third key;
determining at least one potential output based on the monitored inputs; and
generating a final output based on the at least one potential output.

2. A system as recited in claim 1, wherein the gesture input comprises a gesture input performed with first, second, and third fingers of a hand.

3. A system as recited in claim 1, wherein the gesture input comprises a gesture input performed with first, second, and third fingers of a hand, wherein the first key is dimensioned and positioned relative to the input device based on an input location of the first finger, the second key is dimensioned and positioned relative to the input device based on an input location of the second finger, and the third key is dimensioned and positioned relative to the input device based on an input location of the third finger.

4. A system as recited in claim 1, wherein the gesture input comprises a gesture input performed with first, second, and third fingers of a hand, wherein the first key is dimensioned and positioned relative to the input device based on an input profile associated with the first finger, the second key is dimensioned and positioned relative to the input device based on an input profile associated with the second finger, and the third key is dimensioned and positioned relative to the input device based on an input profile associated with the third finger.

5. A system as recited in claim 1, wherein the gesture input comprises a gesture input performed with first, second, and third fingers of a hand, the operations further including determining, for each of the first, second, and third fingers, an estimated range of motion for the finger relative to an input location for the finger at the input device and the multifinger keyboard is generated based on the estimated range of motion.

6. A system as recited in claim 1, wherein the first key, the second key, and the third key are each dimensioned and positioned relative to the input device based on a device type of the input device.

7. A system as recited in claim 1, wherein the first, second, and third keys each include at least three different input zones that are individually associated with one or more output values.

8. A system as recited in claim 1, wherein the first, second, and third keys each include at least three different input zones that are individually associated with one or more output values, the one or more output values determined based on an input configuration of the multifinger keyboard.

9. A system as recited in claim 1, wherein the first, second, and third keys each include at least three different input zones that are individually associated with one or more output values, wherein a position and dimensions for each of the at least three different input zones are determined based on an input position and an input profile of a finger for which the first, second, or third key is generated.

10. A system as recited in claim 1, wherein the gesture input comprises a gesture input performed with first, second, and third fingers of a hand, the operations further comprising generating an auxiliary key for the three finger keyboard in response to detecting an input initiated by a fourth finger at the input device.

11. A system as recited in claim 1, the operations further comprising determining that a hand used to provide the monitored input has moved in position relative to the input device and generating a new instance of the multifinger keyboard that aligns with the repositioned hand.

12. A computer-implemented method, comprising:
receiving an indication that a gesture input is detected at an input device;
determining an input location and an input profile for each of a first, second, and third finger associated with the gesture input;
generating a multifinger keyboard that includes first, second, and third keys, each of the keys dimensioned and positioned based on the input location and the input profile for each of the first, second, and third fingers associated with the gesture input;
generating an auxiliary key for the multifinger keyboard in response to receiving an indication that an additional input is received at the input device outside an area encompassed by keys of the multifinger keyboard, the additional input generated by a fourth finger; and
monitoring the first key, the second key, the third key, and the auxiliary key for input; and
generating an output based on concurrent inputs to the auxiliary key and one or more of the first key, the second key, or the third key.

13. A computer-implemented method as recited in claim 12, wherein generating the output based on the concurrent inputs includes generating multiple potential outputs and the output is generated from the multiple potential outputs by disambiguating among the multiple potential outputs using a dictionary.

14. A computer-implemented method as recited in claim 12, wherein the first, second, third, and auxiliary keys each include at least three different input zones that are individually associated with one or more output values.

15. A computer-implemented method as recited in claim 12, wherein the first, second, third, and auxiliary keys each include at least three different input zones that are individually associated with one or more output values, each of the one or more output values being associated with a different input type, wherein generating the output is based on an input zone at which input is received and an input type of received input.

16. A computer-implemented method as recited in claim 12, further comprising detecting termination of contact between the input device and one or more of the first finger, the second finger, or the third finger and ending generation of the multifinger keyboard in response to the detection.

17. A computer-implemented method, comprising:
detecting input from a first finger to an input zone of a first key in a multifinger keyboard;
detecting input from a second finger to an input zone of a second key in the multifinger keyboard;
detecting input from a third finger to an input zone of a third key in the multifinger keyboard;
determining at least one output value associated with the input zone of the first key, at least one output value associated with the input zone of the second key, and at least one output value associated with the input zone of the second key;
determining multiple potential outputs, the multiple potential outputs including potential combinations of the at least one output value associated with the input zones of the first, second, and third keys; and
generating a final output from the multiple potential outputs.

18. A computer-implemented method as described in claim 17, wherein the input from the first finger, the input from the second finger, and the input from the third finger are concurrently detected.

19. A computer-implemented method as described in claim 17, the operations further comprising displaying a subset of the multiple potential outputs, wherein the final output is generated in response to user selection of one of the subset of the multiple potential outputs.

20. A computer-implemented method as described in claim 17, wherein the at least one output value associated with the input zone of the first key, the at least one output value associated with the input zone of the second key, and the at least one output value associated with the input zone of the second key are determined based on an input configuration of the multifinger keyboard.
